(19) United States
(12) Patent Application Publication
(10) Pub. No.: US 2013/0279413 A1
(43) Pub. Date: Oct. 24, 2013

(54) COMMUNICATION TERMINAL FOR AN ALARM SYSTEM

(71) Applicant: RÉSEAU MULTI NETWORKS INC., La Prairie (CA)

(72) Inventor: Gaétan CÔTÉ, Quebec (CA)

(73) Assignee: Reseau Multi Networks Inc., La Prairie (CA)

(21) Appl. No.: 13/868,519

(22) Filed: Apr. 23, 2013

Related U.S. Application Data
(60) Provisional application No. 61/636,806, filed on Apr. 23, 2012.

(51) Int. Cl. H04L 12/56

(52) U.S. Cl. CPC H04L 45/22
USPC 370/328; 370/352

(57) ABSTRACT

An interface module in the form of a communication terminal for coupling to an alarm system that allows routing both analog and digital communications between the alarm system and a remote recipient through a digital network selected by the terminal and therefore independently from the alarm system. Embodiments of the communication terminal include an analog phone line emulator connectable to the alarm system, at least one digital network coupler such as a cellular module and an Ethernet port, and a controller coupled to both the at least one digital network coupler and to the analog phone line emulator for allowing communications therebetween. The terminal allows communicating alarm messages from the alarm system to an alarm central via the selected digital network and also allow VoIP communications to make phone calls and remote configuration of the alarm system, terminal or other devices connected thereto.

### CROSS REFERENCE TO RELATED APPLICATIONS

This application claims the benefit of U.S. Provisional Application No. 61/636,806, filed on Apr. 23, 2012, the contents of which are incorporated by reference herein.

### BACKGROUND

The present disclosure relates to alarm systems.

More specifically, the present disclosure relates to a communication terminal for an alarm system.

Conventional alarm/security systems include one or a plurality of sensors that are connected to an intrusion detection system for sending their signal thereto. In some alarm systems, the intrusion detection system dials a predetermined number or emit an alarm sound when one of the sensors detects a security breach. In other systems, the intrusion detection system is connected to an alarm central so as to send thereto signals from the sensors or a message indicative of a security breach. The intrusion detection system is conventionally connected to the central through a public switched telephone network (PSTN).

Some conventional alarm systems are further equipped with cellular backup systems that create a fail-safe communication path from the intrusion detection system to the central monitoring station via a GSM or CDMA cellular data network.

However, cellular backup systems are mainly used, as their names suggest, as communication backups in case of unavailability of the landline communication link, and the conventional alarm systems remain limited in the way they are connectable to an alarm central. Also, the link created by the cellular backup is responsive to a signal or message received or sent by the alarm system. It has been found that such limitations of conventional alarm systems further limit their functionalities.

### SUMMARY

An object of illustrated embodiments is to provide an alarm system with additional connectivity and functionalities.

The problem of limited connectivity of an alarm system is solved by coupling an interface module to the alarm system that allows both analog and digital communications of the alarm system through a digital network such as Internet.

In accordance with an illustrative embodiment, there is provided a communication terminal comprising:

at least one alarm system coupling module connectable to an alarm system i) for communicating messages therewith, and ii) for selective a) digitization of the messages, yielding digitized messages or b) digital-to-analog conversion of the digitized messages into the messages;

at least one digital network coupler for allowing a connection with a corresponding digital network; and

a controller coupled to both the at least one digital network coupler and the at least one alarm system coupling module i) for communication of the digitized messages with the at least one alarm system coupling module, and ii) for communication of the digitized messages through the digital network corresponding to a selected one of the at least one digital network coupler.

According to another embodiment, the communication terminal forms a communication system with a gateway server that is connectable to the communication terminal through the corresponding digital network for routing the messages between the communication terminal and an alarm system managing computer.

According to another illustrative embodiment, there is provided a communication interface adapted for coupling to an alarm system and to at least one digital communication network, for allowing communications between the alarm system and a remote device through the at least one digital communication network, and for mimicking the device so that the alarm system is unaware of the at least one digital communication network.

Other objects, advantages and features will become more apparent upon reading of the following non-restrictive description of illustrative embodiments thereof, given by way of example only with reference to the accompanying drawings.

### BRIEF DESCRIPTION OF THE DRAWINGS

In the appended drawings:

FIG. 1 is a schematic view of a communication terminal according to an illustrative embodiment; the terminal being illustrated connected to an alarm system;

FIG. 2 is a block diagram showing the device of FIG. 1 within a network environment;

FIGS. 3A and 3B are block diagrams showing the implementation of a Voice Over Internet Protocol (VOIP) connection by the terminal of FIG. 1;

FIG. 4 is a block diagram illustrating the connection of the terminal from FIG. 1 to the alarm system for the configuration thereof by a remote computer through a VoIP communication;

FIGS. 5A and 5B are block diagrams illustrating the connection of the alarm system to the terminal of FIG. 1 for its configuration by a remote computer through a cellular link;

FIGS. 6A and 6B are block diagrams illustrating the connection of the alarm system to the alarm central via the terminal of FIG. 1 and through a cellular link; and

FIGS. 7A and 7B are block diagrams illustrating the connection of the alarm system to the alarm central via the terminal of FIG. 1 and through a VoIP communication.

### DETAILED DESCRIPTION

In the following description, similar features in the drawings have been given similar reference numerals, and in order not to weigh down the figures, some elements are not referred to in some figures if they were already identified in a precedent figure.

The use of the word “a” or “an” when used in conjunction with the term “comprising” in the claims and/or the specification may mean “one”, but it is also consistent with the meaning of “one or more”, “at least one”, and “one or more than one”. Similarly, the word “another” may mean at least a second or more.

As used in this specification and claim(s), the words “comprising” (and any form of comprising, such as “comprise” and “comprises”), “having” (and any form of having, such as “have” and “has”), “including” (and any form of including, such as “include” and “includes”) or “containing” (and any form of containing, such as “contain” and “contains”), are inclusive or open-ended and do not exclude additional, unrecited elements.

The expression “module” is to be construed in the description and in the claims as any hardware component or components subset that is designed to produce one of more specific functions.

The expression “communicating” is to be construed in the description and in the claims so as to include one or both of “receiving” and “transmitting”.

The expression “message” is to be construed in the description and in the claims as an information or a piece of information that is readable by a digital or analog processor or device.

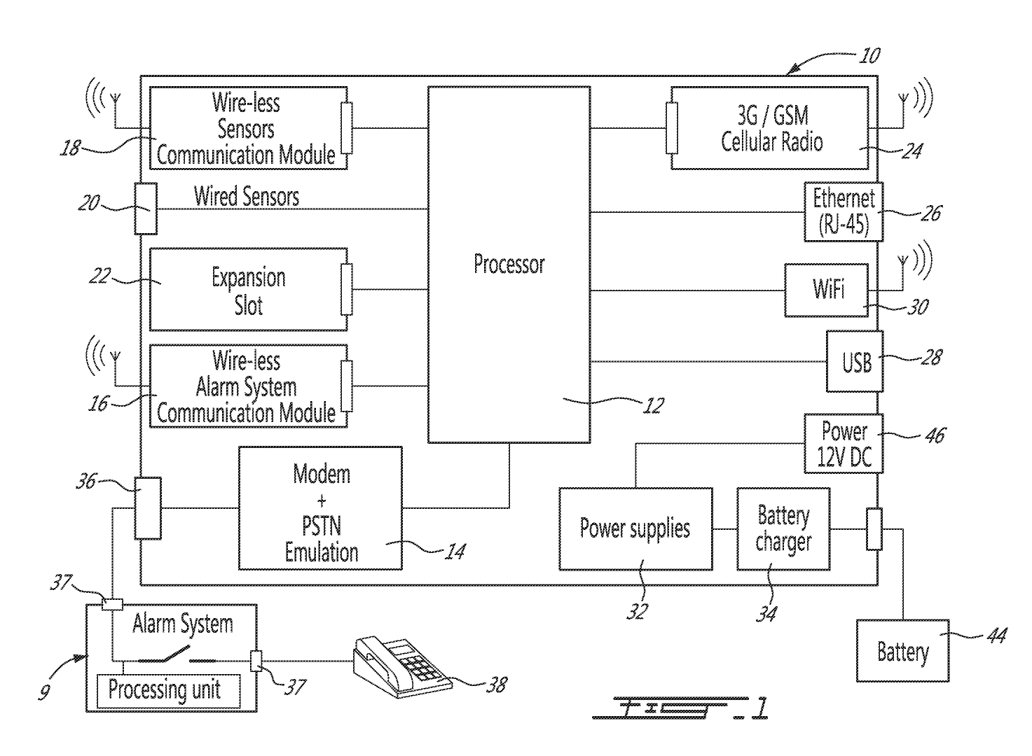

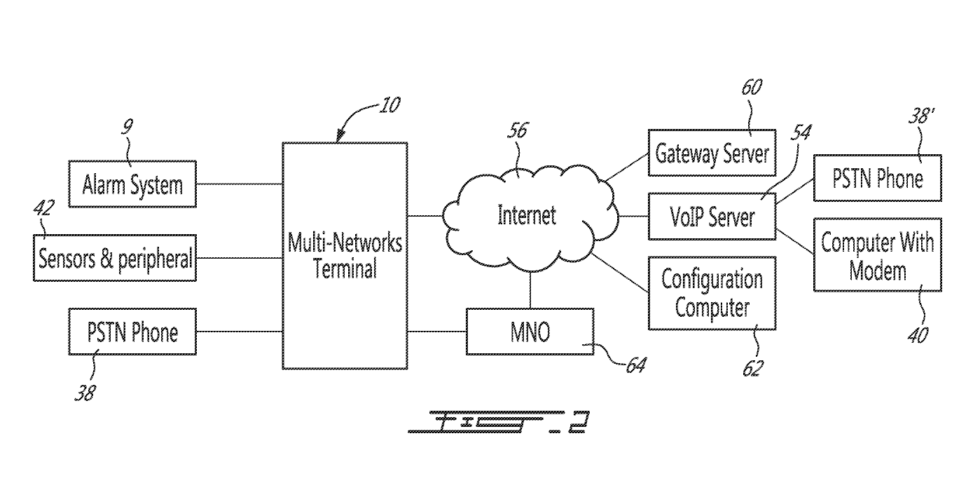

With reference first to FIGS. 1 and 2, a communication terminal 10 according to an illustrated embodiment will be described. As will become more apparent upon reading the following description, the terminal 10 acts as a gateway between an alarm system 9 and an alarm central 11 in addition to allowing the implementation of additional services such as without restrictions VoIP phone calls.

The terminal 10 is operable with any alarm system that is configured for communication through a public switched telephone network (PSTN). Since alarm systems and PSTN are believed to be well-known in the art, they will not be described herein in more detail. As will be described hereinbelow in more detail, the alarm system 9 is connected to the terminal 10 by wires or wirelessly.

The communication terminal 10 comprises a controller 12, a first alarm system communication module in the form of an analog phone line emulator module 14 that allows connecting the controller 12 to the alarm system 9, a second alarm communication module 16 that allows wireless coupling of the controller to the alarm system 9, a wireless sensor communication module 18, a sensor port 20, an expansion slot 22, a plurality of digital network couplers, including i) a cellular communication module 24, ii) Ethernet and USB ports 26 and 28, and iii) a Wi-Fi module 30, a power supplies 32 and a battery charger 34.

The controller, modules, ports and power components 12-34 are assembled in a compact case (not shown) on a conventional printed circuit board (PCB) and the modules, ports and power components 14-34 are operatively connected to the controller 12. The modules 14-18, 24-26, and 30 are also directly or indirectly connected to the power supplies 32. Since the methods and means of assembly and interconnections of electronic and electrical components including power supplies are believed to be well-known in the art, they will not be described furtherin in more details.

Each of the components 12-34 of the communication terminal 10 will now be described in more detail.

According to the illustrated embodiment, the controller 12 is a general purpose processor. More specifically, the controller 12 is in the form of an ARM9 processor. It is to be noted that the processor 12 is connected to random access memory (RAM) and a NAND memory storage which are not illustrated to simplify FIG. 1.

The terminal 10 is not limited to being provided with such embodiments of working and storage memories. Other well known internal or external memory means can be coupled to the processor 12 to allow its operation. For example, a well-known flash memory can be provided to store any information used by the processor 12, including operation codes and data. The memory also allows remotely or on-site updating of the alarm system 9 or terminal 10. Any one of the digital network couplers 24-30 cellular module 24 can be used to input the update information.

The controller 12 is not limited to a ARM9 processor. According to other embodiments (not shown), the controller 12 is in the form of another processor configured according to a Harvard, von Neumann or another architecture. According to the first embodiment, the processor implements the Linux operating system. According to other embodiments, the processor is configured to implement another operating system. Generally stated, the processor 12 acts as a gateway between the alarm system 9 and each of the digital network couplers 24-30 to route messages therebetween.

Other configuration and functionalities of the processor 12 will be described hereinbelow in more detail.

The analog phone line emulator module 14 emulates behaviors of a public switched telephone network (PSTN) or of a PSTN device so as to allow normal operations of the alarm system 9 and of a landline telephone 38 connected thereto even though both are not connected to a PSTN.

Generally stated, emulating or mimicking a behavior of a remote device includes without limitations emulating one or more responses of the device when sending or receiving a message or signal.

More specifically, the module 14 is configured to generate a dial-tone when the alarm system 9 wants to connect to the central 11 or when a telephone 38 is picked-up by a user for an outgoing call. Such a telephone 38 can be connected directly to the module 14 as shown in FIG. 2 or via the alarm system 9 as shown in FIG. 1. The module 14 is also configured to emulate the behavior of a PSTN line for an incoming call, for example by generating and sending a signal to the phone 38 that will cause it to ring.

The emulator module 14 further decodes the dual tone multifrequency (DTMF) key signals received from the phone 38 or alarm system 9. This allows the alarm system 9 to generate DTMF frequencies used in some alarm system configuration protocol and therefore allows communications between the alarm system 9 and alarm central 11 through the terminal 10. Examples of such alarm system protocols include without limitations SIA (Security Industry Association) and Contact ID. It is to be noted that the terminal 10 is not limited to any system alarm protocol. The terminal 10 communicates messages between the alarm system 9 and an alarm central 11 or a remote computer 62 without further processing of the message or acting accordingly.

The module 14 further emulates a modem to receive the analog telephone line signal from the alarm system 9 and as such is configured for receiving the well-known frequency-shift-keying (FSK) technique. Examples of such other protocols include without limitations SIA (Security Industry Association) and Contact ID.

According to the illustrated embodiment, the module 14 is configured to allow communications between the alarm system 9 and a central 11 or a remote computer 40 using a selected one in a plurality of communication protocols. According to another embodiment, the module 14 is configured to allow communications between the alarm system 9 and a central 11 or a remote computer 40 using a single predetermined communication protocol.

The analog phone line emulator module 14 communicates with remote devices or systems via the processor 12 which recognizes the signatures of i) messages from the emulator 14 that originates from the alarm system 11 or phone 38 and ii) messages from any one of digital network couplers 24-30 that originates from a remote system or device and that are intended to the alarm system 9 or phone 38. The emulator 14 dispatches such messages accordingly as will be described furtherin in more detail.

The module 14 is provided with a RJ11 port 36 for connection to respective compatible input/output ports 37 of the alarm system 9 using conventional compatible cables. The module 14 is not limited to such port 36 and can be additionally or alternatively be provided with another port type allowing connecting the alarm system 9 to the terminal 10 via the module 14. For example, a twin screw terminal (not shown) can be provided on the terminal 10 in addition or alternatively to the port 36. Such a twin screw terminal allows connection to an alarm system provided with such similar twin screw terminal.

The wireless alarm system communication module 16 allows wireless communication between the processor 12 and the alarm system 9.

The module 16 is adapted to the specification of the alarm system 9 and can be easily changed or modified to allow wireless communications between the processor 12 and another alarm system (not shown). More specifically, the module 16 is adapted for communication with the alarm system 9 through the communication protocol implemented in the Alarm system 9 and using for example a frequency from the well-known Industrial, Scientific and Medical (ISM) such as, without limitations, 433 MHz, 345 MHz, 900 MHz, 313 MHz and 2.4 GHz. According to some embodiments, the wireless module 16 is configured to operate under another frequency or frequency band range. Examples of wireless protocols and standards include Bluetooth™, Z-wave™, ZigBee™ and Wi-Fi.

According to other embodiments (not shown), the module 16 is omitted. Since wireless communications and alarm system wireless communications are believed to be well-known in the art, they will not be described herein in more detail for concision purposes.

The wireless sensor communication module 18 is provided to wirelessly connect wireless alarm sensors 42 to the processor 12. The module 12 is adapted to receive, recognize and translate signals from wireless alarm sensors and to send messages indicative of the received wireless signals to the processor 12.

The terminal 10 further comprises a sensor port 20 for powering and directly connecting sensors to the processor 12 using connectors or cables.

Examples of typical wired or wireless sensors for an alarm system includes, without limitations, motion sensors, doors and windows entry sensors, water level sensors, etc. The terminal 10 is not limited to any sensor function, configuration or brand, and any one of modules 16 and 18 can be adapted for communication with other different sensors than those listed. The modularity of the communication modules 14, 16 and 18 allows easily adapting the terminal 10 for the communication protocol and specification used by the alarm system 9 and sensors and or peripheral 42.

The wireless sensor communication module 18 and sensor port 20 enable the terminal 10 to monitoring the sensors connected to the alarm system 9. This allows assessing malfunctions of these sensors or of the alarm system 9 by the terminal 10 and to act accordingly, including sending a message to the alarm central 11 to that effect.

For example, according to another embodiment (not shown), the terminal 10 is configured for Bluetooth™ communications, for example via a Bluetooth™ sensor (not shown), for detecting the proximity of a smartphone or another Bluetooth™ enable device (both not shown) and to deactivate the alarm system 9 upon detection of such a device. According to still another embodiment, the terminal 10 allows enabling phone communications under one or more cellular plans using a PSTN phone 38 connected directly to the terminal 10 or via the alarm system 9.

The terminal 10 can be further configured to allow receiving one or more modules in addition to those listed herein. According to the first illustrated embodiment, the terminal 10 is provided with an expansion slot 22 and sufficient room in its casing to receive such an additional module.

According to another embodiment, any one or all of the wireless alarm system communication module 16, wireless sensors module 18, sensor port 20, and expansion slot 22 can be omitted.

The cellular communication module 24 is in the form of a 3G/GSM cellular radio communicator. Such module 24, which is believed to be well known in the art, allows cellular communications to be sent and received by the processor 12 through GPRS (General Packet Radio Service) via GSM (Global System for Mobile Communication).

More generally, the module 24 is configured for communication under a specific one of any well-known cellular standards. As mentioned hereinabove with references to the modules 16 and 18 for example, providing the above-mentioned functionalities through a module allows using a pre-certified cellular communication module. This is also true for the other modules within the terminal 10.

According to the first illustrated embodiment, the module 24 is configured for multi-frequency operation, including, without limitations, operation under the HSPA (High Speed Packet Access) and AWS (Advanced Wireless Services). According to a more specific aspect, the module 24 enables five (5) frequencies. Advantages of such multi-frequency operation include:
improved protection against cellular jammers;
lowering the alarm system downtime by allowing communication switching from a network which is down to a working network; and
increasing the number of network selections of the terminal to route communications from the alarm system 9 to the remote device 9, 50 or 62.

The Ethernet port 26 is in the form of a well-known RJ-45 port that allows communications of the terminal 10 and more specifically of the processor 12 through Internet 56. The RJ45 port 26 is connected to the processor 12 via an integrated circuit (not shown) that converts messages from the microcontroller 12 to the Ethernet standards and vice-versa. A transducer (not shown) is connected to both the integrated circuit and to the RJ45 port 36 therebetween to both isolate the connector port 26 from the integrated circuit and to filter interfering radio waves.

Connection of the processor 12 to Internet is also allowed wirelessly via the Wi-Fi module 30.

In both cases of connection to Internet via the Ethernet port 26 or Wi-Fi via the module 30, the processor 12 is configured with parameters required to establish a connection. These parameters and the connection to Internet 56 are provided by an Internet provider. Since such a connection to Internet 56 is believed to be within the reach of a person skilled in the art, it will not be described herein in more detail.

The terminal 10 further includes a USB-type connector 28 or another similar connector for connecting a peripheral, such as without limitations, a well-known Wi-Fi or cellular key (both not shown).

A power system is provided that includes a battery 44 connected to the processor 12 via the power supplies 32 and battery charger 34 and a power connector 46 or cable adapted to receive electricity from the power outlet.

The power supplies 32 includes conventional power converters allowing to energize the processor 12, modules 14-18, the digital network couplers 24-30, etc. The power supplies 32 are configured for power failure detection from the power connector 46 and for rerouting power to the microcontroller 12 from the battery 44.

The battery charger 34 is provided to monitor the battery charge and charge the battery 44 when its charging level is low and when the terminal 10 uses less power than provided at the input 46.

According to the illustrated embodiment, the battery 44 is of the Li-Ion type. Typical operational voltage of the terminal 10 is twelve (12) volts under about a 1200 ma current. These battery type and operational power ranges are only provided for illustrative purposes. It is believed to be within the reach of a skilled technician to conceive a terminal 10 using the present teaching for operation under other power input values.

According to another embodiment, the power failure detection functionality is omitted in the power system. According to another embodiment, the number and/or nature of the power source are different than those illustrated.

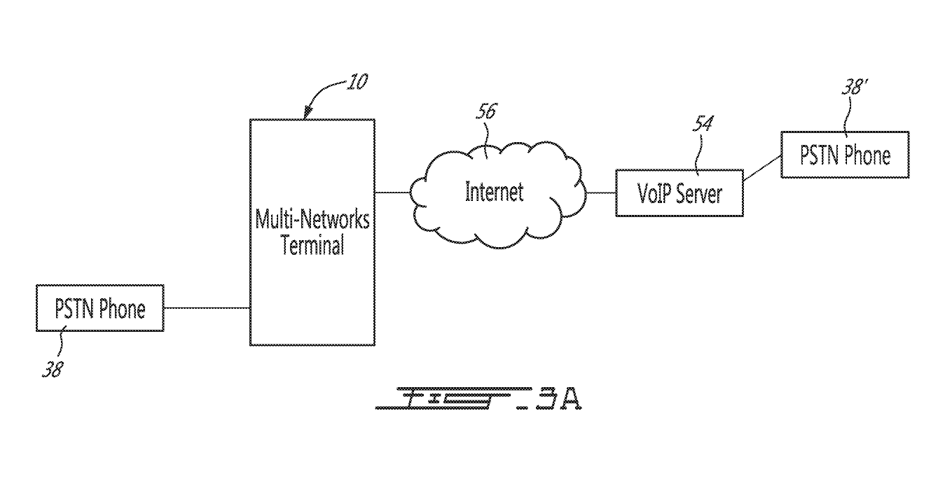

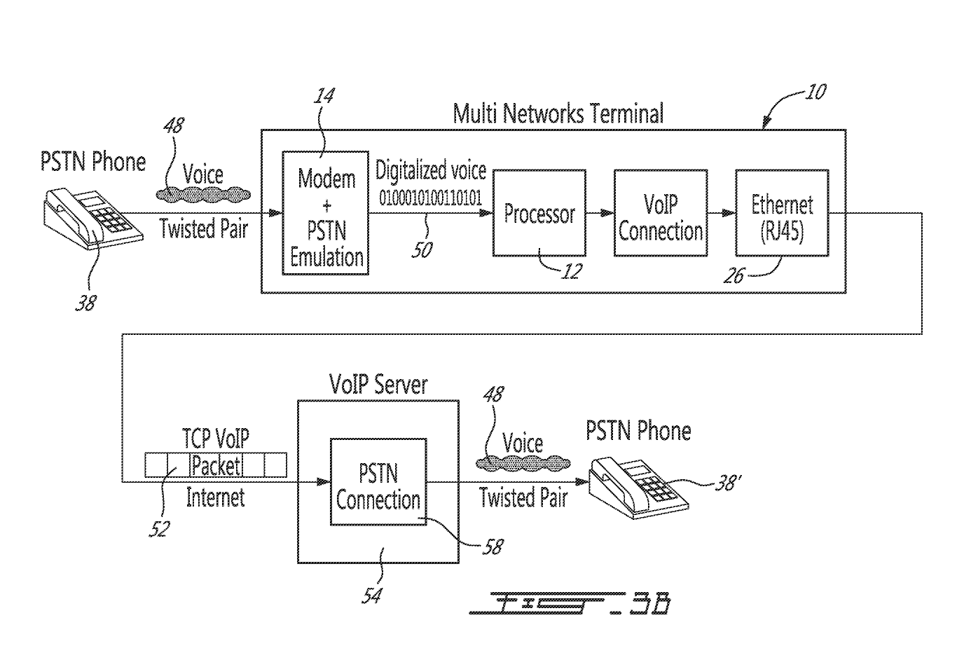

Other characteristics and functionalities of the terminal 10 will become more apparent upon reading the following description of connection examples allowed thereof given with references to FIGS. 3A to 7B.

The operation of the terminal 10 will now be described in more detail. As will be exemplified in more detail furtherin, alarm system related messages are routed by the processor 12 between the alarm system 9 and a selected one of i) the 3G radio module 24 for cellular transmission and ii) to one of the RJ45 Ethernet port 26 and WiFi module 30 for transmission via Internet. The terminal 10 acts independently from the alarm system 9 and the choice between the transmitting a message from the alarm system 9 via one network and/or another is also independent from the alarm system 9. In other words, the alarm system 9 determines the recipient of the message and the terminal 10 determines the route used to communicate the message to the recipient. According to some embodiment, the terminal 10 is configured so as a single route is available thereto.

With reference first to FIGS. 3A-3B, the terminal 10 can be used as an ATA (Analog Telephone Adapter) to allow VoIP (Voice Over Internet Protocol) phone conversation.

As described hereinabove, the terminal 10, via its analog phone line emulator module 14, is operated to emulate a PSTN phone line so as to allow communication by the PSTN phone 38. The PSTN phone 38 is either connected directly to the terminal 10 or indirectly through the Alarm system 9. It is to be noted that connecting the PSTN phone 38 to the terminal 10 via the alarm system 9 allows given priority call to the alarm system in case of a detected violation.

With reference to FIG. 3B, the voice sounds 48 from the PSTN phone 38 are digitized by the emulator module 14 and the resulting digitized message 50 is sent to the processor 12. The message 50 is then processed so as to yield TCP (Transmission Control Protocol) packets 52 that are indicative of the original sounds and compatible with the VoIP protocol implemented on the VoIP server 54.

An internet VoIP connection is established between the terminal 10 and the VoIP server 54 and the packets 52 are sent by the processor 12 through Internet 56. The VoIP server 54 then processes the received message so as to reconstruct the voice sound 48 that is redirected to the destination phone 38′ through a PSTN connection 58 or Internet 56.

Conversely, when digitized voice is received by the terminal 10 from the VoIP server 54, the received IP packets are reconstructed into a digitized voice message by the processor 12 that is then sent to the phone line emulator module 14 that converts the digitized message into an analog voice sound. It is to be noted that the PSTN phone 38 on the side of the terminal 10 has been previously assigned a phone number by the VoIP service provider (not shown).

Considering the above, a person skilled in the art will appreciate that arrangements can be made, wherein the only fees to expect for using the terminal 10 for VoIP communications are those set for the use of Internet 56 by the Internet service provider. The use of the terminal 10 may therefore allow a user to save on long-distance calls depending on predetermined conditions set for example in a well-known utilization program or plan.

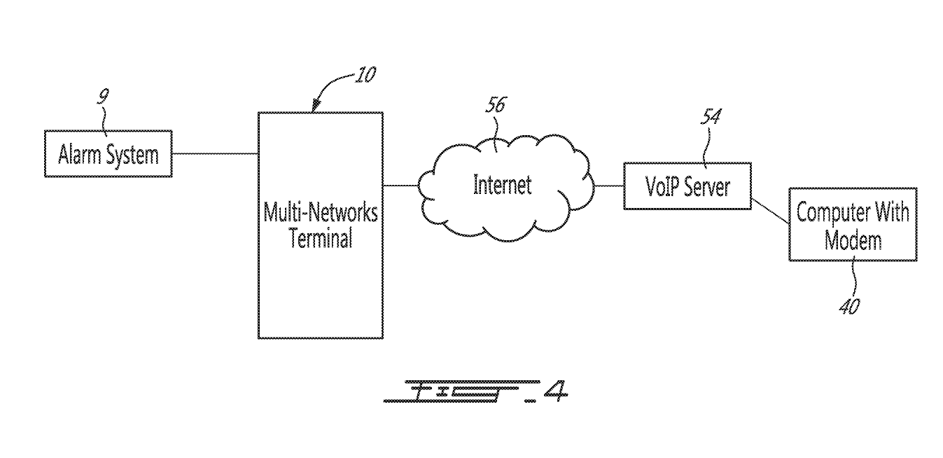

As illustrated in FIG. 4, the VoIP connection described hereinabove can be used by a technician or another person to configure the alarm system 9 from a remote computer 40 equipped with a modem. The alarm system 9 is configured to answer a call after a given number of rings. Also, as mentioned hereinabove, the module 14 is configured to selectively emulate a modem.

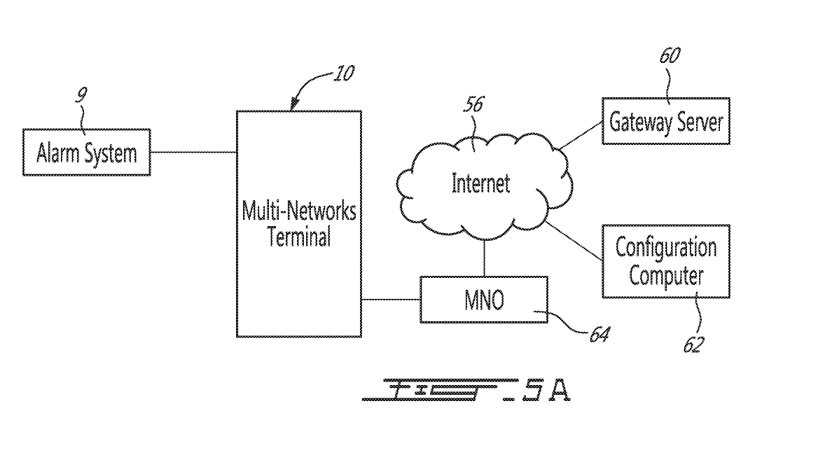

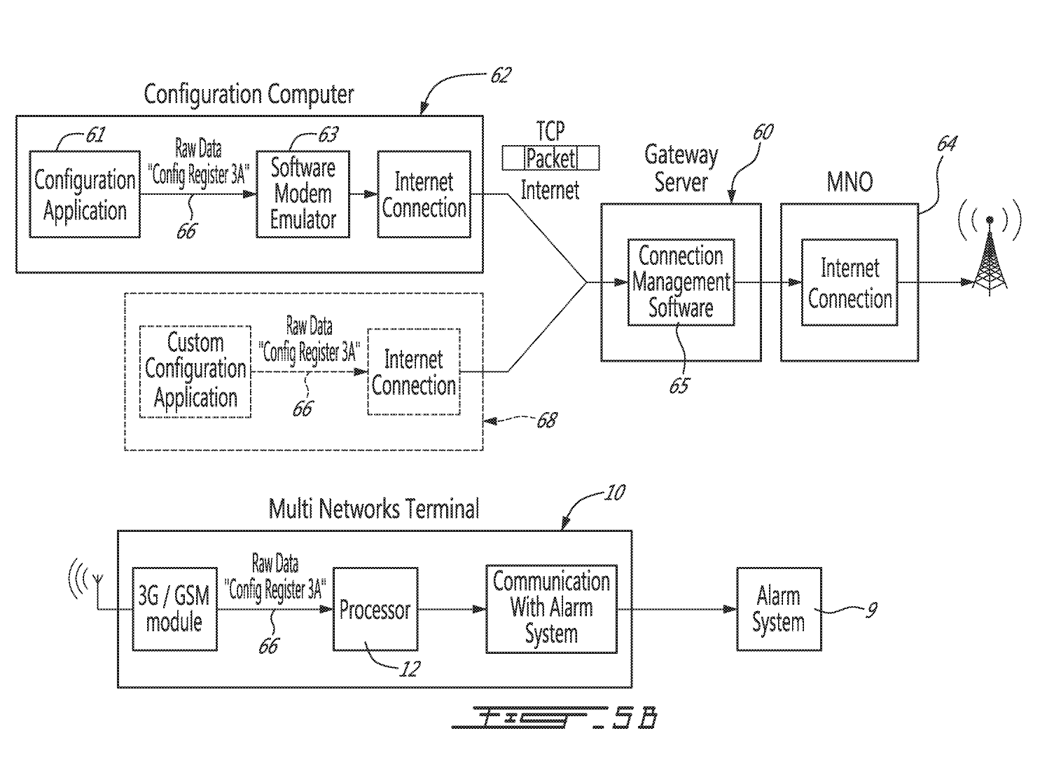

With references now to FIGS. 5A and 5B, the use of the terminal 10 for the remote configuration of the alarm system 9 via a cellular link will be described.

To achieve such a remote configuration, a first connection is established through Internet 56 between the terminal 10 and a gateway server 60 and a second connection is established between a configuration computer 62 and the gateway server 60 also through Internet 56.

The gateway server 60 is configured for connecting to Internet 56 and for acting as a communications gateway between the configuration computer 62 and the terminal 10 through a mobile network operator (MNO) 64. As such, the gateway server 60 is also configured for cellular communication through the MNO 64.

The configuration computer 62 is a general purpose computer, such as a personal computer, a tablet, a smartphone, etc., that is configured for Internet access and for operating as a terminal to send configuration command to the alarm system 9. The configuration computer 62 includes a configuration application 61 that allows receiving configuration data (not shown) from a file or from an input device, generating raw data 66 therefrom and communicating the raw data to the gateway server 60. The configuration computer 62 also includes a modem emulator 63 that mimics a direct connection to the alarm system 9 while the raw data 66 is sent to the gateway server 60.

The configuration data is sent as raw data 66 from the configuration computer 64 to the gateway server 60 through Internet 56. Knowing the cellular number assigned to the terminal 10 by the MNO 64, the gateway server 60 communicates the raw data 66 to the terminal 10 through the MNO 64.

As can be seen in dashed line in FIG. 5B, a configuration computer 68 according to a second embodiment is configured to include a custom configuration application that can communicate the raw data 66 directly to the gateway server 60 without requiring the modem emulator 63.

The terminal 10 then mimics the configuration computer 62 and sends the configuration command as raw data 66 to the alarm system 9 via its emulator module 14.

According to the first embodiment, the terminal 10 remains connected at all time to the gateway server 60. According to another embodiment, the terminal 10 communicates periodically with the gateway server 60 to gather configuration updates therefrom. According to still another embodiment, the gateway server 60 sends a short message service (SMS) text message to the terminal via the MNO network to request that the terminal 10 establishes a connection as shown in FIG. 5B. According to still another embodiment, the terminal 10 is configured to select one of the previously-mentioned connection request methods using a predetermined rule. Example of such a rule is to select the least expensive request methods. The terminal 10 and or the gateway server 60 is then configured to track or get the MNO usage and the costs of all considered options.

The gateway server 60 can either be a dedicated server or a server hosting the service allowing the above-described functionalities of the server 60.

The expression server should be construed in the description and in the claims as a computer configured for Internet access and for hosting at least one service.

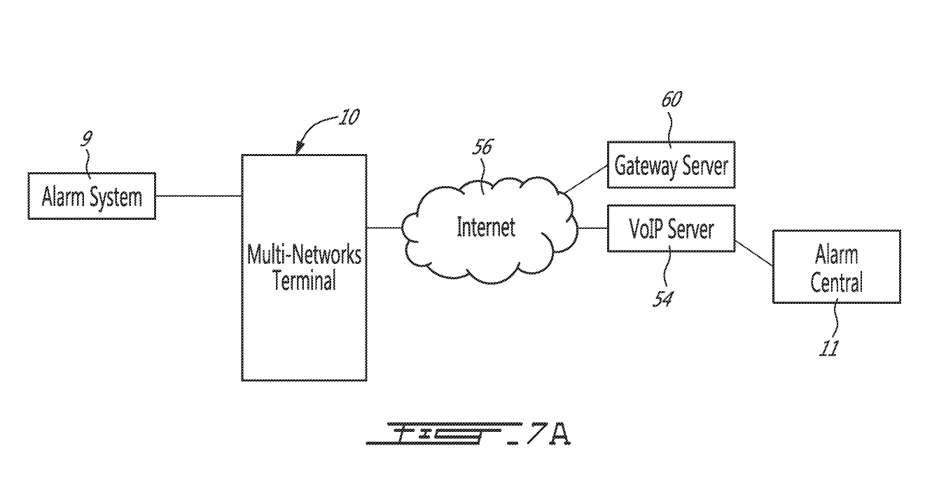

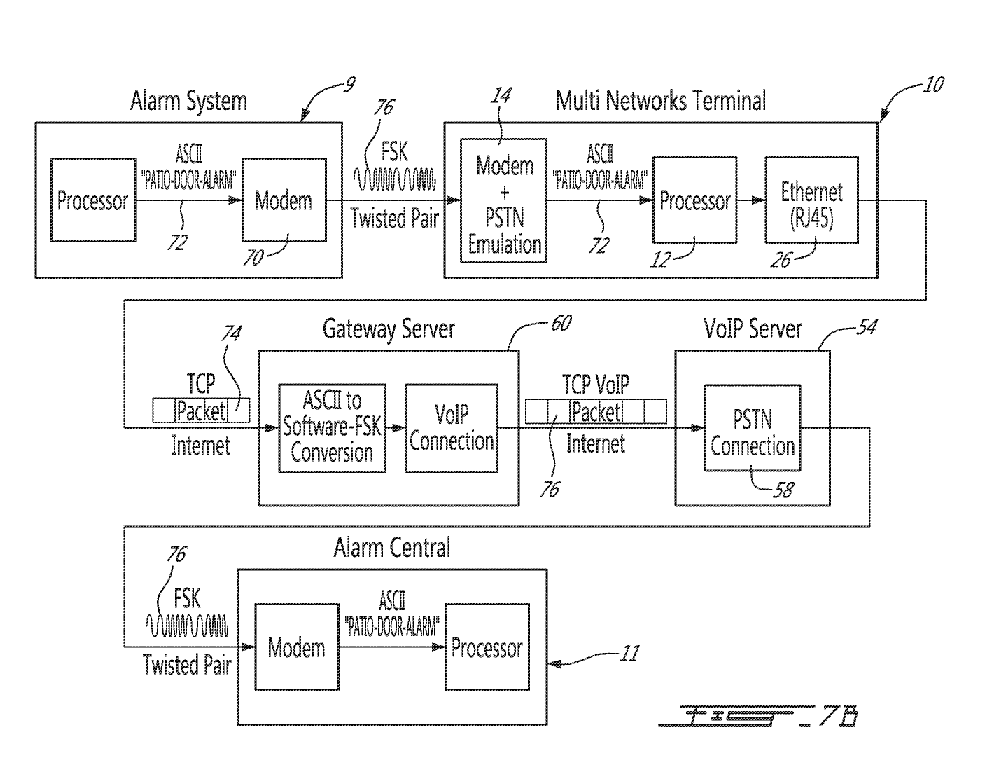

The operation of the terminal 10 to establish a communication channel between the alarm system 9 and an alarm central 11 or more generally with a computer with a modem will now be described. As will be described hereinbelow in more details with reference to FIGS. 7A-7B, the communication can be established via Internet 56.

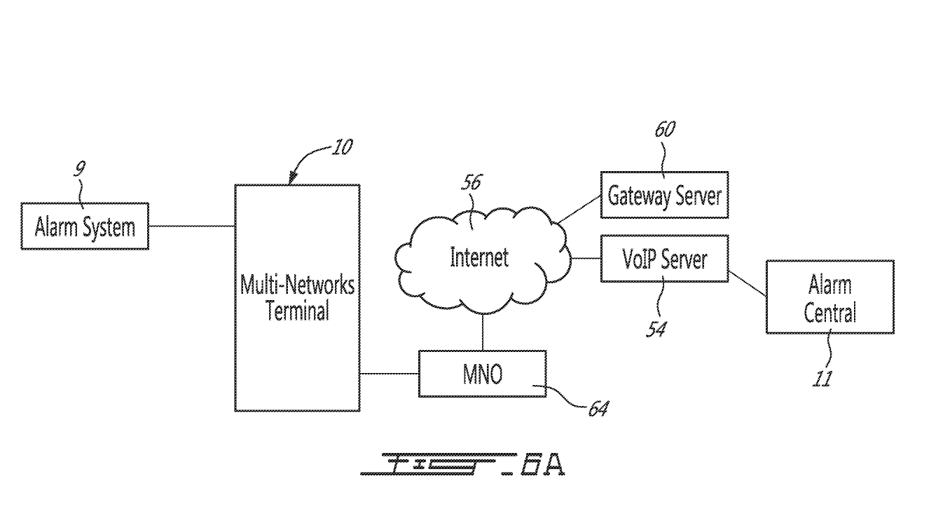

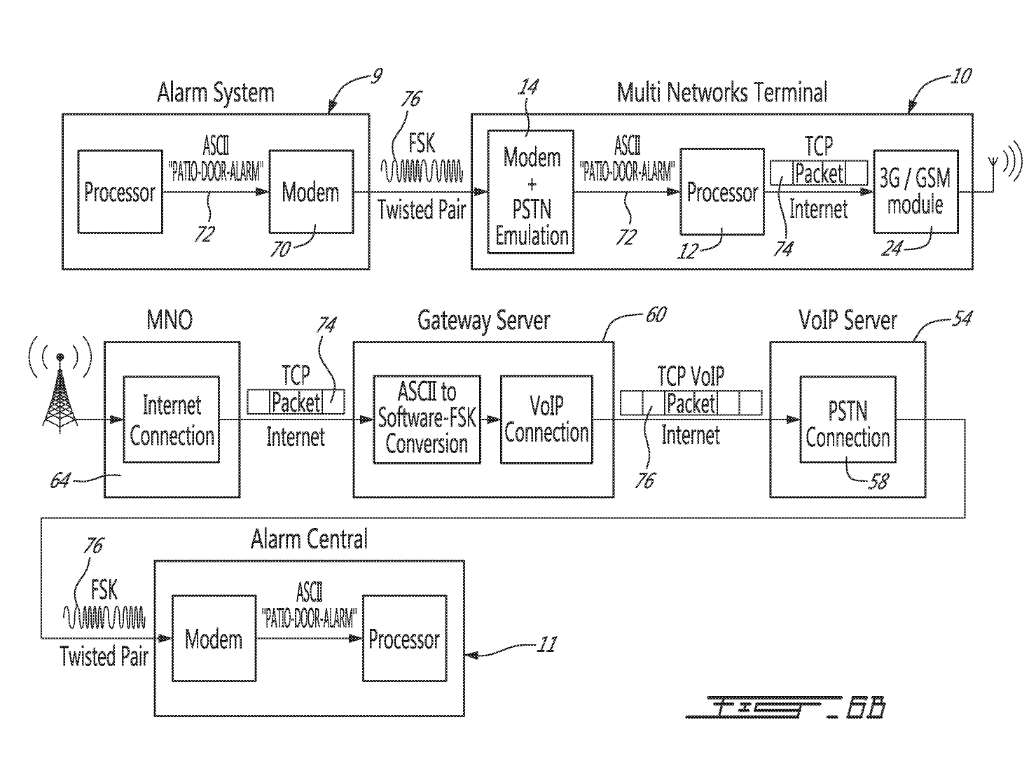

As will first be described with reference to FIGS. 6A-6B, the communication between the alarm system 9 and the alarm central 11 can be established by the terminal 10 via the MNO 64.

An alarm central 11 can be considered similar to the computer with modem 40 from FIG. 4. Connections to an alarm central 11 using the terminal 10 will therefore share similarities to the one described with reference to FIG. 4. Generally stated, both the alarm central 11 and the configuration computer 62 can be considered alarm system managing computers.

The alarm system 9 is configured to send to the alarm central 11 a message indicative of a breach using ASCII (American Standard Code for Information Interchange) codes such as “PATIO-DOOR-ALARM” 72 by modem 70. The terminal 10 then establishes a VoIP communications with the alarm central 11 in order to send the sound produced by its modem 70. For such a purpose, the ASCII message 72 is translated by the alarm system 9 using FSK.

In the case wherein the alarm system 9 is of the type that communicates through PSTN, the emulation module 14 of the terminal 10 emulates a PSTN line as described hereinabove and mimics the behavior of the alarm central 11 so as to receive from the alarm system 9 and acknowledge thereto the receipt of the message indicative of the breach 72.

Then the terminal 10 via its module 14 hangs up to the alarm system 9 and the message 72 is sent to the processor 12. The processor 12 digitizes the message and sends it as Internet packets 74 to the gateway server 60 through the MNO 64 via its cellular communication module 24.

The gateway server 60 then converts the ASCII alarm message 72 into the original sound message 76 and forward it to the alarm central 11 via the VoIP server 54.

As a person skilled in the art will now appreciate, the output 76 of the alarm system 9, which is the input 76 at the terminal 10, is identical to the input 76 at the alarm central 11. According to this communication scheme, the terminal 10 emulates the alarm central 11 so that the alarm system 9 acts as if the alarm message was successfully received by the central 11. The terminal 10 further acts as a gateway and works with the gateway server 60 to ensure that the original message 72 from the alarm system 9 is seamlessly routed to the alarm central 11. To achieve this result, the terminal 10, together with the gateway server 60, manages the transmissions first through the MNO 64 and then making use of the VoIP server 54.

The communication route described with reference to FIGS. 6A and 6B can be implemented by the terminal 10 for example when the transmission of the breach message 72 cannot be routed directly through Internet 56 as will now be described with reference to FIGS. 7A-7B. This communication route can also be defined by the terminal 10 as the preferred route. Since the routing of the alarm message 72 directly through Internet is similar to the routing through the MNO 64 as described hereinabove, only the differences between the two routes will be described furtherin in more detail for concision purposes.

In this particular case, the terminal 10 sends the ASCII alarm message 72 directly to the gateway server 60 through Internet 56 and does not make use of a MNO 64. All other routing steps are identical to those described with reference to FIGS. 6A-6B.

According to another routing method (not shown), the VoIP service is used to directly send the alarm message 72 from the alarm system 9 to the alarm central 11 via the terminal 10 but without the gateway server 60 being involved.

The communication routings involving the terminal 10 as described hereinabove have been only provided to exemplify the functionalities and characteristics thereof. It is believed to be within the reach of a person skilled in the art to use the above teachings to use the terminal 10 to allow other connections and communications involving the alarm system connected thereto or other similar devices.

It is to be noted that many other modifications could be made to the terminal 10 described hereinabove and illustrated in the appended drawings. For example:
the terminal 10 can be made alternatively or additionally connectable to another network than Internet, such as without limitations a closed private Ethernet network;
the terminal 10 can be provided with conventional LED display (not shown) and/or on/off and reset switches (not shown), a mini screen, a LCD (Liquid Cristal Display) screen, or any other input/output means. For example a board of LEDs (Light-Emitting Diode) (not shown), or any other display type, can be connected to the processor 12 so as to be controlled therefrom according to the state of the on/off and/or reset switches or of any other component of the terminal 10;
the input and output ports of the terminal 10 are not limited in nature or functions to those of the embodiments described herein;
the terminal 10 and more precisely the processor 12 thereof can be configured to assess the operational status of the alarm system 9, including without restriction its operational power, transmission and reception of messages, battery state, etc.;
the terminal 10 is not limited to any number of modules so as to yield the above-described functionalities thereof. According to another embodiment, some or all of the functionalities of the modules are provided by the controller; and
the terminal can be provided with additional ports such as without limitations infrared (IR) ports and/or a RS-232 port to couple to the terminal 10 wireless IR devices such as air conditioners, sound systems, home theater devices, etc. so as to be controlled thereby remotely or on site.

All communication standards and protocol mentioned hereinabove are only given for illustrative purposes. It is believed to be within the reach of a person skilled in the art to modify the terminal 10 for communicating data under other standards and/or networks.

It is to be understood that embodiments of the terminal are not limited in their application to the details of construction and parts illustrated in the accompanying drawings and described hereinabove. Other embodiments can be foreseen and practiced in various ways. It is also to be understood that the phraseology or terminology used herein is for the purpose of description and not limitation.

1. A communication terminal comprising:
at least one alarm system coupling module connectable to an alarm system i) for communicating messages therewith, and ii) for selective a) digitization of the messages, yielding digitized messages or b) digital-to-analog conversion of the digitized messages into the messages;
at least one digital network coupler for allowing a connection with a corresponding digital network; and
a controller coupled to both the at least one digital network coupler and the at least one alarm system coupling module i) for communication of the digitized messages with the at least one alarm system coupling module, and ii) for communication of the digitized messages through the digital network corresponding to a selected one of the at least one digital network coupler.

2. A communication terminal as recited in claim 1, wherein the alarm system communicates the messages with a remote device; the controller being further adapted to mimic the remote device.

3. A communication terminal as recited in claim 1, wherein the at least one digital network coupler includes at least one of a cellular communication module, a Wi-Fi module and an Ethernet port.

4. A communication terminal as recited in claim 3, wherein the cellular communication module allows the controller communicating the digitized messages through GPRS (General Packet Radio Service) via GSM (Global System for Mobile Communication).

5. A communication terminal as recited in claim 3, wherein the controller is adapted to open the connection with a mobile network using the cellular communication module.

6. A communication terminal as recited in claim 1, wherein the messages include a configuration command for the alarm system; the controller being further adapted to use the connection to receive the configuration command from a remote device.

7. A communication terminal as recited in claim 1, wherein the at least one digital network coupler allows the controller communicating the digitized messages through Internet.

8. A communication terminal as recited in claim 1, wherein the at least one alarm system coupling module emulates behavior of a public switch telephone network (PSTN).

9. A communication terminal as recited in claim 8, wherein the behavior of a PSTN includes at least one of:
generating and sending a PSTN signal to the alarm system for causing a telephone connected to the alarm system to ring;
decoding dual tone multi frequency DTMF key signals received from one of the telephone connected to the alarm system and the alarm system; and
emulating a modem.

10. A communication terminal as recited in claim 1, wherein the at least one alarm system coupling module is adapted to operatively couple at least one of a PSTN telephone and the alarm system to the controller by emulating a PSTN telephone line.

11. A communication terminal as recited in claim 10, wherein at least some of the messages are in the form of sounds and the digitized messages are digitized sounds.

12. A communication terminal as recited in claim 11, wherein the controller being adapted for communicating the digitized sounds, through the at least one digital network coupler, with a voice over Internet protocol (VoIP) server for communication with another PSTN telephone.

13. A communication terminal as recited in claim 11, wherein the controller is further adapted to receive through one of the at least one digital network coupler a configuration command for the alarm system, the configuration command being forwarded by a VoIP server; the configuration command being in digitized form; the processor being further adapted for sending the digitized form of the configuration command to one of the at least one alarm system coupling module for transmission of the configuration command to the alarm system.

14. A communication terminal as recited in claim 1, wherein the controller being further adapted to emulate at least one behavior of a recipient of the messages.

15. A communication terminal as recited in claim 1, wherein the at least one digital network coupler includes a cellular communication module that allows a selection of a mobile network among a plurality of mobile networks and enabling said communication of the digitized messages over the selection of a mobile network.

16. A communication terminal as recited in claim 1, wherein one of the at least one alarm system coupling module wirelessly couples the controller to the alarm system.

17. A communication terminal as recited in claim 1, further comprising a sensor communication module for connecting at least one sensor to the controller.

18. A communication terminal as recited in claim 17, wherein the controller further monitors operation of the at least one sensor.

19. A communication terminal as recited in claim 1, being further configured for wirelessly detecting wireless enable devices, and for coupling therewith.

20. A communication terminal as recited in claim 1, further comprising a power system for energizing the controller, the at least one alarm system coupling module and the at least one digital network coupler.

21. A communication system comprising:
a communication terminal as recited in claim 1; and
a gateway server connectable to the communication terminal through the corresponding digital network for routing the messages between the communication terminal and an alarm system managing computer.

22. A communication system as recited in claim 21, wherein the alarm system managing computer includes a modem; the gateway server communicating with the alarm system managing computer via a voice over Internet protocol (VoIP) server.

23. A communication interface adapted for coupling to an alarm system and to at least one digital communication network, for allowing communications between the alarm system and a remote device through the at least one digital communication network, and for mimicking the device so that the alarm system is unaware of the at least one digital communication network.
